(19) United States
(12) Patent Application Publication
(10) Pub. No.: US 2025/0124808 A1
(43) Pub. Date: Apr. 17, 2025

(54) A COMPUTER-IMPLEMENTED METHOD FOR CONSISTENTLY IDENTIFYING AN AGENT FOR A COACHING SESSION, AND ASSESSING RELEVANT COACHING SUBJECT TO THE COACHING SESSION, IN A CONTACT CENTER

(71) Applicant: NICE LTD., Ra'anana (IL)

(72) Inventors: Mahesh BAIRAGI, Pune (IN); Idan VARSHAVSKI, Kiryat Ono (IL); Amol ANWADE, Pune (IN)

(21) Appl. No.: 18/378,714

(22) Filed: Oct. 11, 2023

(51) Int. Cl. G09B 19/00; G06Q 10/0639

(52) U.S. Cl. CPC G09B 19/00; G06Q 10/06393

(57) ABSTRACT

A computer-implemented method for consistently identifying an agent for a coaching-session and assessing relevant-coaching-subject to the coaching-session. The computer-implemented method includes: (i) receiving agents having KPIs below a threshold; for each agent: (ii) receiving focus-area and related behaviors for the KPIs; (iii) retrieving interactions and associated categories and behaviors; (iv) retrieving evaluations of the retrieved interactions that are below a threshold, and related interactions; (v) marking each category that is having an evaluation below the threshold; (vi) retrieving associated focus-area with behaviors for each category that is classified as negative; (vii) determining a number of categories for the coaching-session; (viii) identifying behaviors from interactions related to the categories based on the associated focus-area; (ix) determining a number of behaviors; (x) calculating a co-relation score for each behavior and associated focus-area; and (xi) selecting a number of behaviors and associated focus-area having highest co-relation score to schedule a coaching-session therewith.

### TECHNICAL FIELD

The present disclosure relates to the field of data analysis for consistently identifying an agent for a coaching session, and assessing relevant coaching subject to the coaching session, in a contact center.

### BACKGROUND

In hybrid contact centers, where agents work part of the week from the office and part of the week remotely and face time duration is reduced, supervisors do not spend as much time with the agents as they used to when the agents worked only from the office. Hence, supervisors may not be able to monitor what the agents are doing by going by them to join them side by side when a problem escalates or to notice if an agent is missing or not back from a break or to coach them.

A coach has to perform several manual and time-consuming tasks, such as identifying who to coach and relevant coaching subject matter. To identify who to coach, the coach has to review input such as monitored data from many dashboards and analyze performance Key Performance Indicators (KPI)s and trends, extract meaningful and actionable insights and go over many data points and insights manually. To identify the coaching subject matter, the coach has to process all the input and identify KPIs, focus areas and behavior which require a related coaching subject matter, and then browse several repositories and applications to find the relevant coaching materials and attach them to the coaching session.

These tasks of identifying who to coach and assessment of relevant coaching subject matter, often rely on skills, visibility and judgement of the coach, hence, are subjective in nature and create inconsistency in the system, such that for example, two coaches may arrive at different conclusions, e.g., identified agent to coach and coaching subject matter from the same data. Moreover, the lack of targeted content may impact coaching effectiveness and damages the effective time utilization for both the agent and the coach.

There is a need for a technical solution for consistently identifying an agent for a coaching session, and assessing relevant coaching subject to the coaching session, in a contact center.

### SUMMARY

There is thus provided, in accordance with some embodiments of the present disclosure, a computer-implemented method for consistently identifying an agent for a coaching session, and assessing relevant coaching subject to the coaching session, in a contact center.

Furthermore, in accordance with some embodiments of the present disclosure, the computer-implemented method may include: (i) receiving a list of one or more agents having one or more Key Performance Indicators (KPI) s below a first preconfigured threshold during a preconfigured period to yield a list of agents-for-coaching from a Project Management (PM) component; for each agent in the list of agents-for-coaching: (ii) receiving focus area and related behaviors for the one or more KPIs below the first threshold; (iii) retrieving interactions and associated categories and behaviors during the preconfigured period from an interactions analytics component; (iv) retrieving evaluations of the retrieved interactions that are below a second preconfigured threshold during the preconfigured period, and related interactions from a Quality Management (QM) service; (v) marking each category of one or more categories of each interaction having an evaluation below the second preconfigured threshold to yield a list of marked categories-for-coaching; (vi) retrieving a preconfigured associated focus area for each category in the list of marked categories-for-coaching that is classified as negative. Each focus area has preconfigured one or more behaviors.

Furthermore, in accordance with some embodiments of the present disclosure, the computer-implemented method may further include: (vii) determining a first preconfigured number of categories for the coaching session; (viii) identifying behaviors from interactions related to the determined first preconfigured number of categories for the coaching session based on the retrieved preconfigured associated focus area of the first preconfigured number of categories for the coaching session and based on a preconfigured mapping of categories to focus areas and each focus area of the focus areas to one or more behaviors; (ix) determining a second preconfigured number of behaviors from the identified behaviors for the coaching session; (x) calculating a co-relation score for each behavior in the second preconfigured number of behaviors and associated focus area and sorting the behaviors in descending order based on the calculated co-relation score; and (xi) selecting a third preconfigured number of behaviors and associated focus area having highest co-relation score and scheduling a coaching session with the selected third preconfigured number of behaviors and associated focus area having highest co-relation score to the agent.

Furthermore, in accordance with some embodiments of the present disclosure, the identifying of behaviors from interactions related to the determined first preconfigured number of categories for the coaching session based on the retrieved preconfigured associated focus area of the first preconfigured number of categories for the coaching session may be operated by Support Vector Machines (SVM) models.

Furthermore, in accordance with some embodiments of the present disclosure, the determining of the first preconfigured number of categories for the coaching session may be operated by calculating an average confidence score for each category in the list of marked categories-for-coaching and sorting the categories by the average confidence score in descending order to determine the preconfigured number of categories having the highest confidence score.

Furthermore, in accordance with some embodiments of the present disclosure, the determining of the second preconfigured number of behaviors for the coaching session may be operated by calculating an average score for each behavior in the identified behaviors and sorting the behaviors in ascending order to determine the preconfigured number of behaviors for the coaching session.

Furthermore, in accordance with some embodiments of the present disclosure, the list of agents-for-coaching may further include coaching requests from agents during the preconfigured period.

Furthermore, in accordance with some embodiments of the present disclosure, each category may be mapped to a focus area.

Furthermore, in accordance with some embodiments of the present disclosure, the coaching session may include one or more sessions.

Furthermore, in accordance with some embodiments of the present disclosure, the received one or more KPIs of each agent may include at least one of: (i) abandon rate; (ii) average speed of answer; (iii) Average Handling time (AHT); (iv) service level; (v) productivity; (vi) Customer Satisfaction (CSAT); and (vii) proficiency.

Furthermore, in accordance with some embodiments of the present disclosure, the calculated co-relation for each behavior and associated focus area in the determined second preconfigured number of behaviors for the coaching session is based on an inversed normalized score for the behavior. The inversed normalized score may be calculated by:

inversed normalized score=(max preconfigured score-average score)*(100/max preconfigured score).

Furthermore, in accordance with some embodiments of the present disclosure, the calculating of the co-relation score for each behavior and associated focus area in the determined second preconfigured number of behaviors for the coaching session may be calculated by co-relation score=(median score of focus area*focus-area-weight)+ (average score of behavior*behavior-weight). The average score of behavior is the inversed normalized score.

Furthermore, in accordance with some embodiments of the present disclosure, the scheduling of the coaching session may include scheduling the coaching session in an open slot of a work-shift of each agent from the list of agents-for-coaching that have interactions related to the evaluations of the retrieved interactions that are below a second preconfigured threshold during the preconfigured period.

Furthermore, in accordance with some embodiments of the present disclosure, the computer-implemented method may further include sending a notification to a computerized-device of each agents from the list of agents-for-coaching that have interactions related to the evaluations of the retrieved interactions that are below a second preconfigured threshold during the preconfigured period as to the scheduled coaching session. The notification includes details of the selected preconfigured number of behaviors and associated focus area having highest co-relation score.

Furthermore, in accordance with some embodiments of the present disclosure, when there are no evaluations of the retrieved interactions that are below a second preconfigured threshold during the preconfigured period are received, the agent may be removed from the list of agents-for-coaching.

Furthermore, in accordance with some embodiments of the present disclosure, the identifying of behaviors from interactions related to the determined first preconfigured number of categories for the coaching session based on the retrieved preconfigured associated focus area of the first preconfigured number of categories for the coaching session may be operated by the interactions analytics module.

### BRIEF DESCRIPTION OF THE DRAWINGS

FIGS. 1A-1B schematically illustrate a high-level diagram of a system for consistently identifying an agent for a coaching session, and assessing relevant coaching subject to the coaching session, in a contact center, in accordance with some embodiments of the present disclosure;

FIGS. 2A-2C are a high-level workflow of a computer-implemented method for consistently identifying an agent for a coaching session, and assessing relevant coaching subject to the coaching session, in a contact center, in accordance with some embodiments of the present disclosure;

FIG. 3 shows input sources for consistently identifying an agent for a coaching session, and assessing relevant coaching subject to the coaching session, in a contact center, in accordance with some embodiments of the present disclosure;

FIGS. 4A-4C is a flow diagram for consistently identifying an agent for a coaching session, and assessing relevant coaching subject to the coaching session, in a contact center, in accordance with some embodiments of the present disclosure;

FIGS. 5A-SK show simulation and test results for consistently identifying an agent for a coaching session, and assessing relevant coaching subject to the coaching session, in a contact center, in accordance with some embodiments of the present disclosure; and

FIGS. 6A-6B show screenshots of scheduled coaching sessions for agents, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing.” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

For enhancing agent efficacy, contact centers establish instructional programs for personnel, designed to correspond with their genuine requirements. This is achieved through a comprehensive strategy that incorporates insights derived from numerous applications, alongside industry best practices, evaluation findings, and subject matter relevant to the dissemination of knowledge.

In contact centers, the coach that is responsible for initiating and conducting coaching sessions considers various factors, including the agent's performance, strengths and shortcomings, productivity, and skill level, to pinpoint agents requiring guidance. Upon identification, the instructor engages in a session with the individual receiving coaching, i.e., the coachee to convey the gathered findings and insights. The coachee subsequently utilizes the information acquired during the coaching session to enhance their overall performance, drawing on the covered topics, insights, and any designated assignments to reinforce their learning experience.

In current systems in contact centers, for efficient coaching execution, the coach employs classifications, resources, and tools, collectively referred to as coaching materials. Commonly, the coaching approach incorporates focus areas, behaviors of agents during interactions with customers, and related interactions.

Existing coaching solutions primarily focus on observation of agent performance metrics and its preconfigured mapping with coaching contents, such as focus areas and behavior. The tasks often rely on skills, visibility, and judgement of the coach, hence, are subjective in nature and may create inconsistency between selected coachee and the subject matter assigned to the coaching session.

For example, two coaches can arrive at different conclusions as to who to coach and on which coaching subject matter from the same data. The process of identifying who to coach and then selecting the subject matter for the coaching session is currently centered around improving the agent performance by relying on manual process and human judgment from limited data rather than focusing on a larger set of interactions, evaluations, and historical requests. Lack of coaching identification insights and targeted content may impact coaching effectiveness and negatively impact the effective time utilization for both the coach and coachee.

Therefore, there is a need for computer-implemented method and system for consistently identifying an agent for a coaching session, and assessing relevant coaching subject to the coaching session, in a contact center.

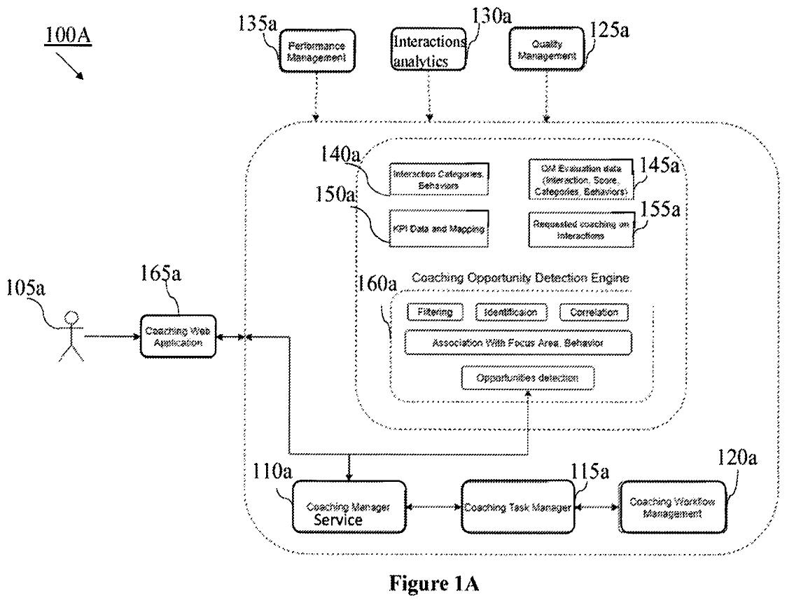

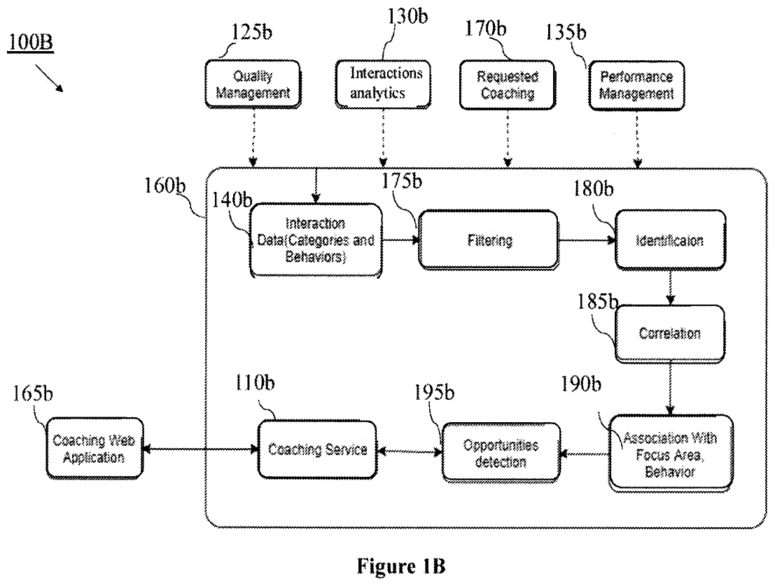

FIG. 1A schematically illustrates a high-level diagram of a system 100A for consistently identifying an agent for a coaching session, and assessing relevant coaching subject to the coaching session, in a contact center, in accordance with some embodiments of the present disclosure.

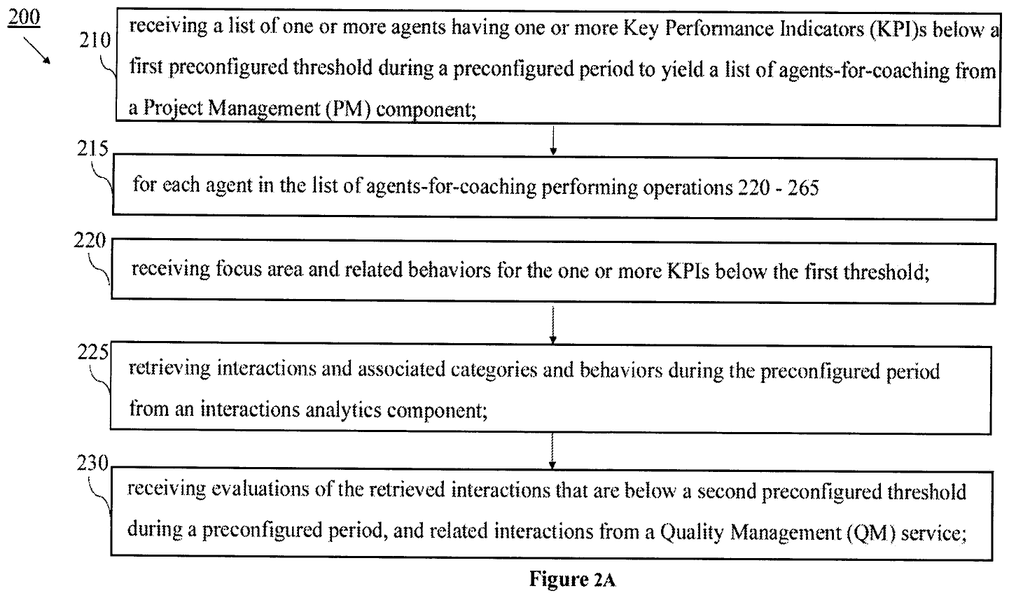

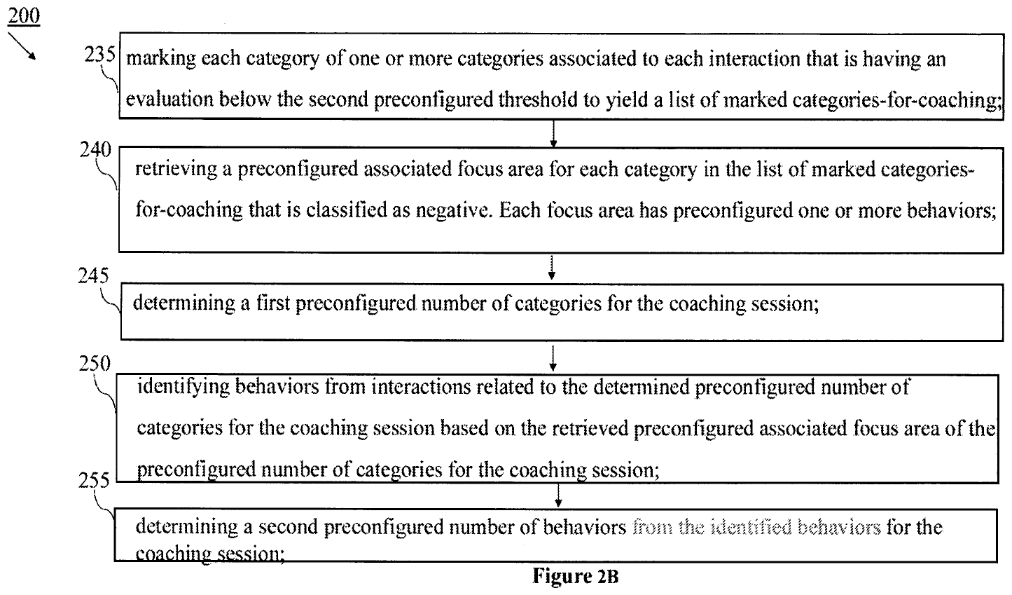

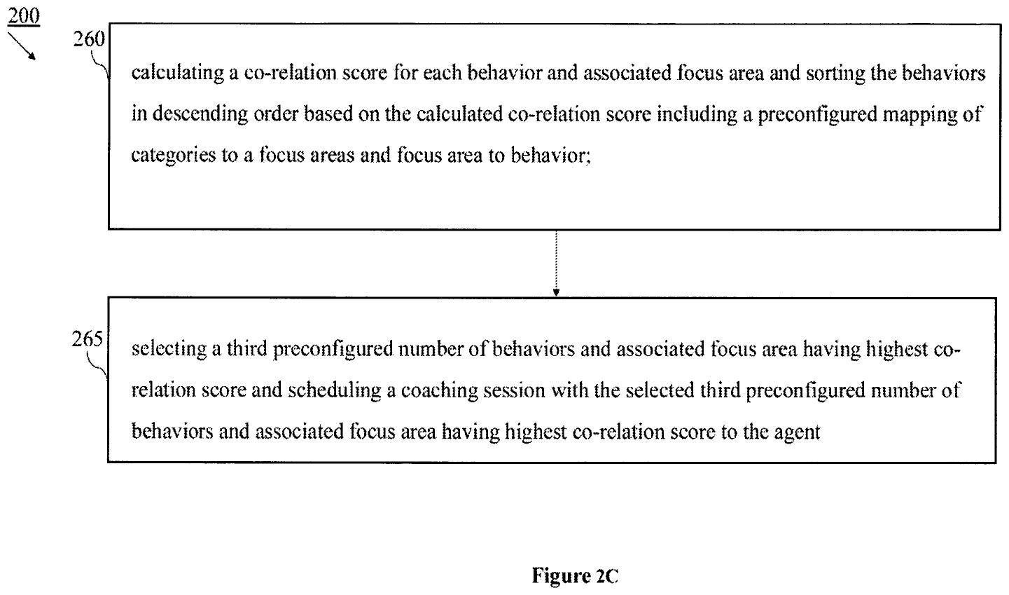

According to some embodiments of the present disclosure, in a system, such as system 100A for consistently identifying an agent for a coaching session, and assessing relevant coaching subject to the coaching session, in a contact center, a user, such as a coach 105a may utilize a coaching web application 165a to generate coaching sessions which are assessed as relevant to an identified agent by an implemented method, such as computer-implemented method 200 in FIGS. 2A-2C for consistently identifying an agent for a coaching session, and assessing relevant coaching subject to the coaching session, in a contact center. Coaching web app 165a may include an interface to assess agents' performance in contact center and statuses for activities such as coaching. User 105a may select an agent, adds objectives, attaches relevant documents and adds comments, tasks as a part of coaching session after the relevant coaching subject to the coaching session has been assessed.

According to some embodiments of the present disclosure, a coaching manager service 110a may generate coaching sessions and may interact with additional services to guarantee a comprehensive completion of session creation. This coaching manager service 110a service may receive data from the web application 165a such as a selected agent for coaching and may establish a coaching session within the system. The coaching session may include subject matter that is assessed by the implemented method as related to behaviors during interactions with customers that require performance elevating by the agent. Optionally, after the relevant coaching subject to the coaching session has been assessed, the coach may additionally enter objectives for the coaching session comments, tasks and may attach relevant documents.

According to some embodiments of the present disclosure, the coaching task manager 115a may maintain task-related information of coaching sessions. For example, an acknowledgment task to be performed by the agent, status update to be performed by system 100A, and the like.

According to some embodiments of the present disclosure, coaching workflow management 120a may handle the creation and management of workflows of each coaching session. These workflows of the coaching sessions may be implemented using any workflow service, such as Amazon Web Servs

According to some embodiments of the present disclosure, a quality management component 125a of the contact center may include information related to the evaluations of agents interactions.

According to some embodiments of the present disclosure, interactions analytics 130a may maintain information about interactions and analytics, such as summarization of interaction, one or more categories associated to each interaction, behaviors of the agent and sentiments of agent and customer during each interaction.

According to some embodiments of the present disclosure, Performance Management (PM) component 135a may maintain information of one or more Key Performance Indicator (KPI) s for each agent, i.e., KPI data and mapping to coaching focus area and behavior 150a. Computer-implemented method 200 in FIGS. 2A-2C for consistently identifying an agent for a coaching session, and assessing relevant coaching subject to the coaching session, in a contact center, a list of one or more agents having one or more KPIs which are below a first preconfigured threshold during a preconfigured period may be retrieve, from the PM component 135a, to yield a list of agents-for-coaching.

According to some embodiments of the present disclosure, interaction categories behaviors 140a may be retrieved form interactions analytics component 130a. The categories which are labeled as negative, hence may require improvement of agent performance, may be considered. For example, abandonment call, disconnected call, no answer, customer escalated, contacted multiple times, agent curses, agent unhelpful, negative chat, agent difficult to understand and agent unhelpful.

According to some embodiments of the present disclosure, quality management evaluation data, evaluation score, categories, and behaviors 145a may be retrieved from quality management component 125a. Computer-implemented method 200 in FIGS. 2A-2C for consistently identifying an agent for a coaching session, and assessing relevant coaching subject to the coaching session, in a contact center may retrieve quality management evaluations which are below a second preconfigured threshold during the preconfigured period and related interactions during that preconfigured period.

According to some embodiments of the present disclosure, requested coaching on interactions 155a may maintain requested coaching sessions from agents on any interaction. Since the coaching sessions are directly requested from the agents this data is not filtered by parameters, such as KPI below a first threshold or evaluations of interactions which are below the second preconfigured threshold during the preconfigured period of time.

According to some embodiments of the present disclosure, a coaching opportunity detection engine 160a may implement computer-implemented method 200 in FIGS. 2A-2C for consistently identifying an agent for a coaching session, and assessing relevant coaching subject to the coaching session, in a contact center to analyze the received data. For example, coaching opportunity detection engine 160a may consume one or more KPIs for the agent which are below the first preconfigured threshold, that have been retrieved from the PM component 135a, evaluations of the retrieved interactions that are below a second preconfigured threshold during the preconfigured period from the quality management 125a, and interactions and associated one or more categories and behaviors during the preconfigured period retrieved from interactions analytics component 130a. Based on the analysis of the received data relevant coaching opportunities may be assessed for the identified agent.

According to some embodiments of the present disclosure, the received one or more KPIs of each agent may be at least one of: (i) abandon rate); (ii) average speed of answer; (iii) Average Handling time (AHT); (iv) service level; (v) productivity; (vi) Customer Satisfaction (CSAT); and (vii) proficiency.

According to some embodiments of the present disclosure, the analysis of the coaching opportunity detection engine 160a may include marking each category of the one or more categories associated to each interaction that is having an evaluation below the second preconfigured threshold to yield a list of marked categories-for-coaching and then retrieving a preconfigured associated focus area for each category in the yielded list of marked categories-for-coaching that is classified as negative. A category may be classified or labeled as negative when it is related to an area that requires agents performance improvement.

According to some embodiments of the present disclosure, each focus area has preconfigured one or more behaviors mapped to it. The mapping of the behaviors to a focus area may be stored in a local storage or in an associated database.

According to some embodiments of the present disclosure, the analysis of the coaching opportunity detection engine 160a may further include determining a first preconfigured number of categories for the coaching session and then identifying behaviors related to the determined first preconfigured number of categories for the coaching session based on: (i) retrieved preconfigured associated focus area of the first preconfigured number of categories for the coaching session; and (ii) preconfigured mapping of categories to focus areas and each focus area of the focus areas to one or more behavior.

According to some embodiments of the present disclosure, the determining of the first preconfigured number of categories for the coaching session may be operated by calculating an average confidence score for each category in the list of marked categories-for-coaching and sorting the categories by the average confidence score in descending order to determine the preconfigured number of categories having the highest confidence score.

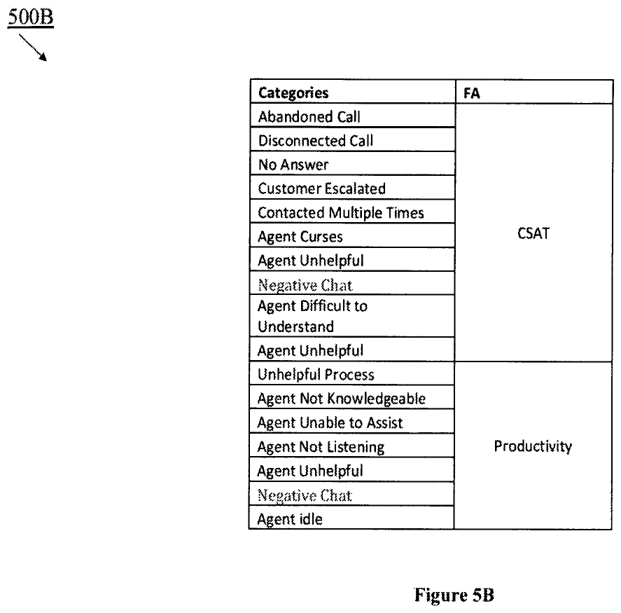

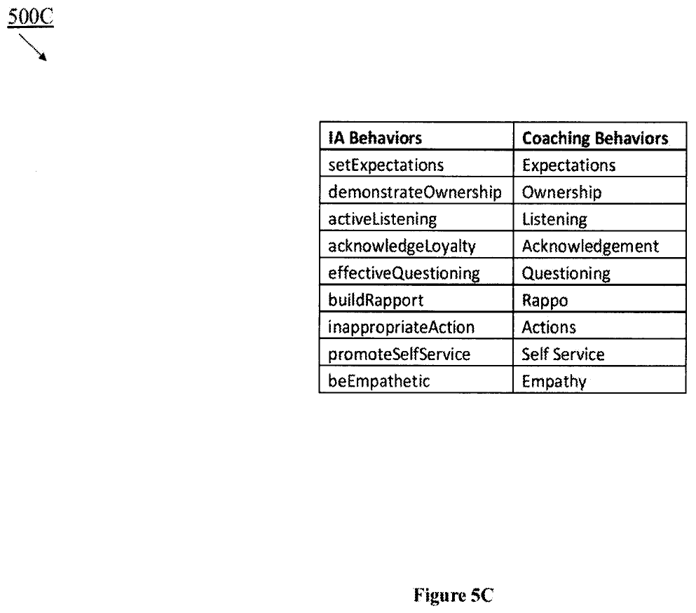

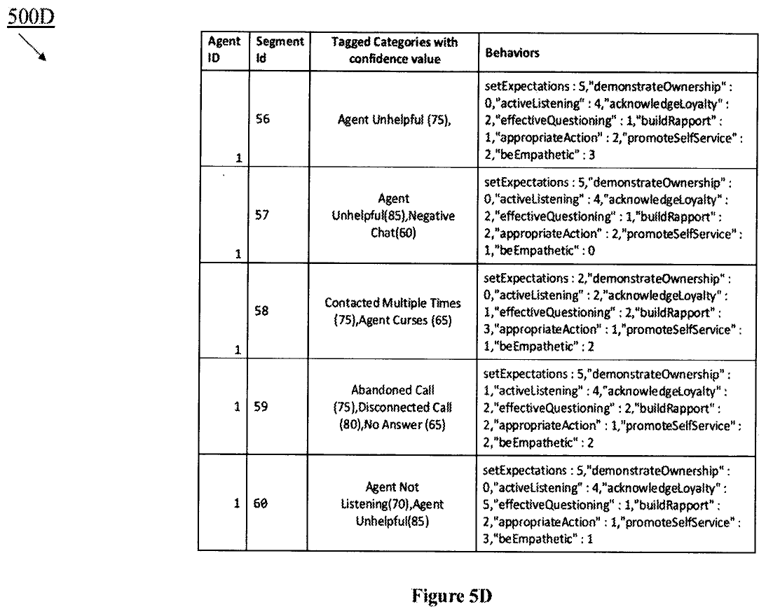

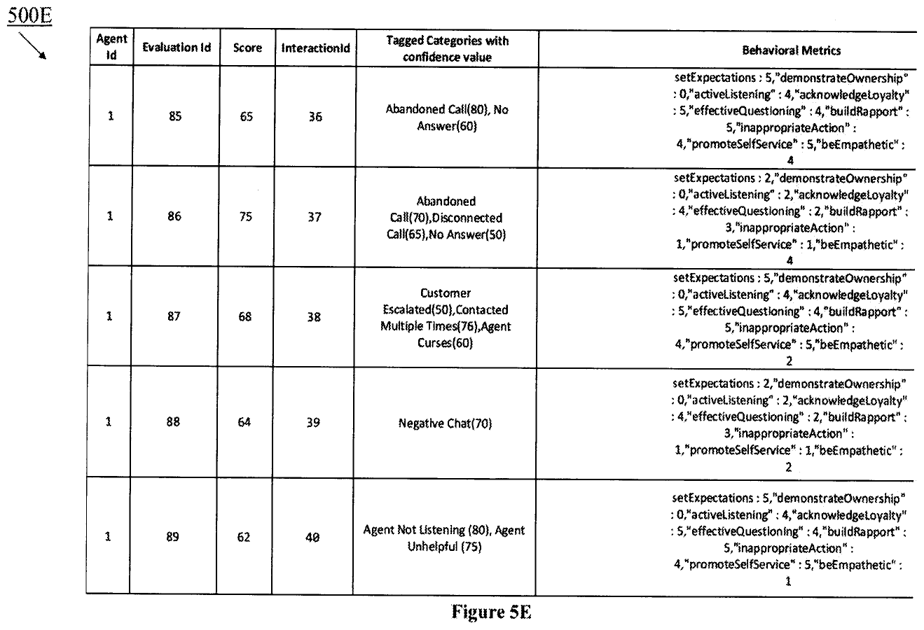

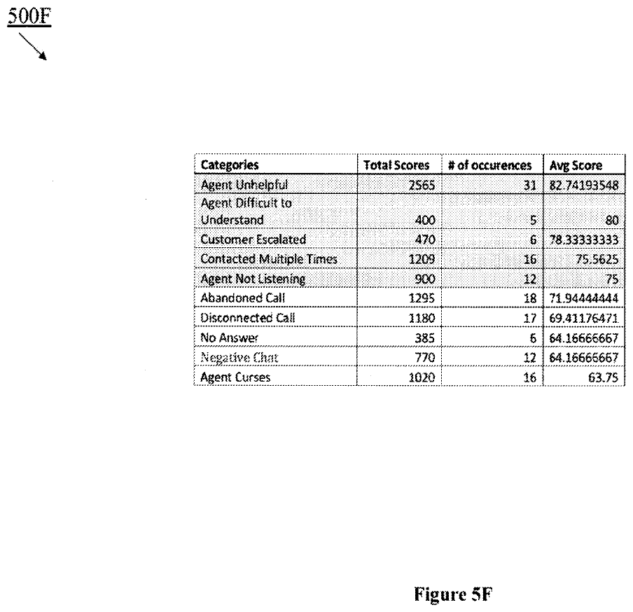

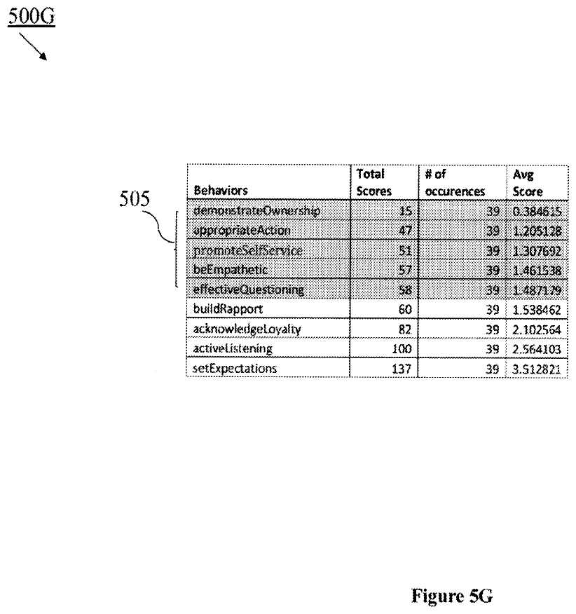

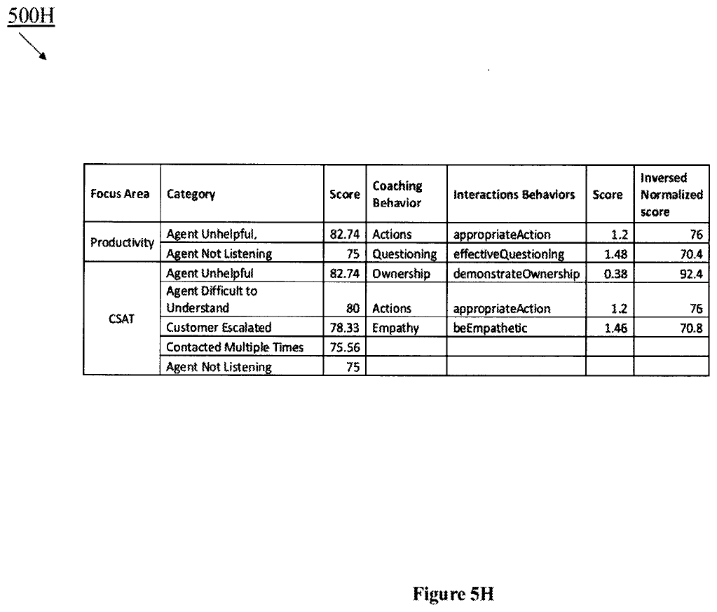

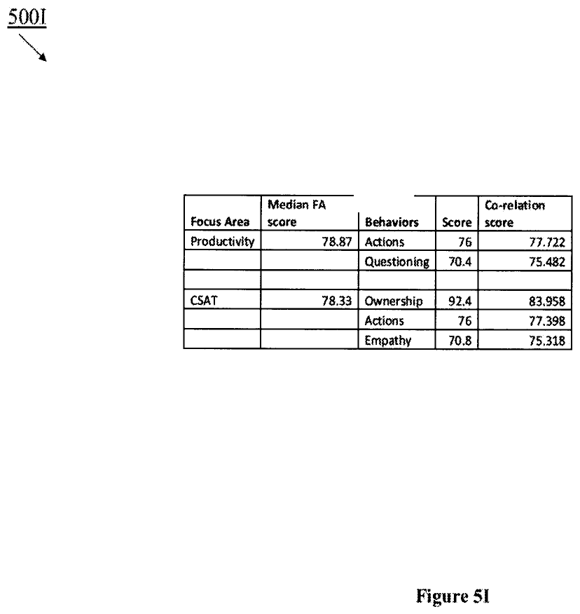

According to some embodiments of the present disclosure, behaviors from interactions related to the determined first preconfigured number of categories for the coaching session may be identified based on the retrieved preconfigured associated focus area of the first preconfigured number of categories for the coaching session and based on a preconfigured mapping of categories to focus areas for example, as shown in FIG. 5B and each focus area of the focus areas to one or more behaviors, for example, as shown in FIG. 5A.

According to some embodiments of the present disclosure, the interactions analytics component 130a may operate a machine learning model to identify the one or more behaviors and the machine learning model may provide a confidence score for each identified behavior in the interaction. Only behaviors from the identified behaviors that have a confidence score above ‘0’ which has been provided by the machine learning model may be considered.

According to some embodiments of the present disclosure, the identifying of behaviors from interactions related to the determined first preconfigured number of categories for the coaching session based on the retrieved preconfigured associated focus area of the first preconfigured number of categories for the coaching session may be operated by the interactions analytics component 130a.

According to some embodiments of the present disclosure, a second preconfigured number of behaviors may be determined from the identified behaviors for the coaching session and then a co-relation score may be calculated for each behavior in the second preconfigured number of behaviors and associated focus area, for example, as shown in FIG. 51 and in FIG. 5K.

According to some embodiments of the present disclosure, the determining of the second preconfigured number of behaviors for the coaching session may be operated by calculating an average score for each behavior in the identified behaviors and sorting the behaviors in ascending order to determine the preconfigured number of behaviors for the coaching session.

According to some embodiments of the present disclosure, the second preconfigured number of behaviors may be sorted in descending order based on the calculated co-relation score and then a third preconfigured number of behaviors and associated focus area having highest co-relation score may be selected for scheduling a coaching session with the selected third preconfigured number of behaviors and associated focus area having highest co-relation score to the agent. The scheduling of the coaching session with the selected third preconfigured number of behaviors and associated focus area having highest co-relation score may include scheduling the coaching session in an open slot of a work-shift of the agent to be triggered at the scheduled open slot of the work-shift.

According to some embodiments of the present disclosure, the coaching session may include one or more sessions, each may be scheduled in a different open slot of one or more work-shifts.

According to some embodiments of the present disclosure, the calculated co-relation for each behavior and associated focus area in the determined second preconfigured number of behaviors for the coaching session may be based on an inversed normalized score for the behavior, and the inversed normalized score is calculated by:

inversed normalized score=(max preconfigured score-average score)*(100/max preconfigured score).
whereby:
max preconfigured score is a maximum score for the behavior, and
average score is an average score of the behavior during the preconfigured period.

According to some embodiments of the present disclosure, the calculating of the co-relation score for each behavior and associated focus area in the determined second preconfigured number of behaviors for the coaching session may be calculated by the following formula:

co-relation score=(median score of focus area*focus-area-weight)+(average score of behavior*behavior-weight),
whereby:
median score of focus area is a median score of preconfigured mapped categories to the focus area, focus-area-weight is a preconfigured weight,
average score of behavior is the calculated inversed normalized score of the behavior, and behavior-weight is a preconfigured weight.
   The value of the focus-area-weight is in the range of ‘0’ to ‘1’. For example, focus-area-weight may be preconfigured to be ‘0.6’ and the behavior-weight may be preconfigured to be ‘0.4’.

According to some embodiments of the present disclosure, a notification may be sent to a computerized-device of the agent as to the scheduled coaching session. The notification may include details of the selected third preconfigured number of behaviors and associated focus area having highest co-relation score which are the relevant coaching subject for the coaching session.

According to some embodiments of the present disclosure, when no evaluations of the retrieved interactions that are below a second preconfigured threshold during the preconfigured period are received for the agent, the agent may be removed from the list of agents-for-coaching.

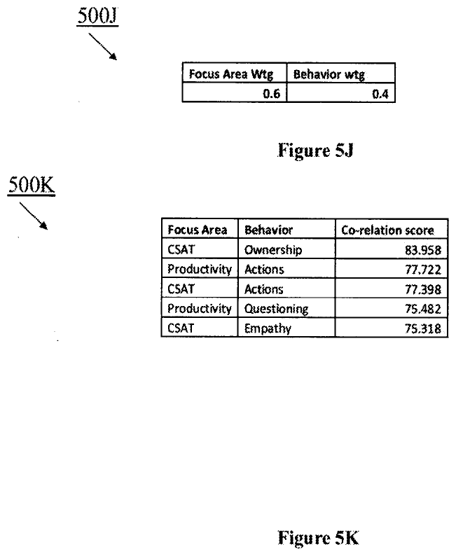

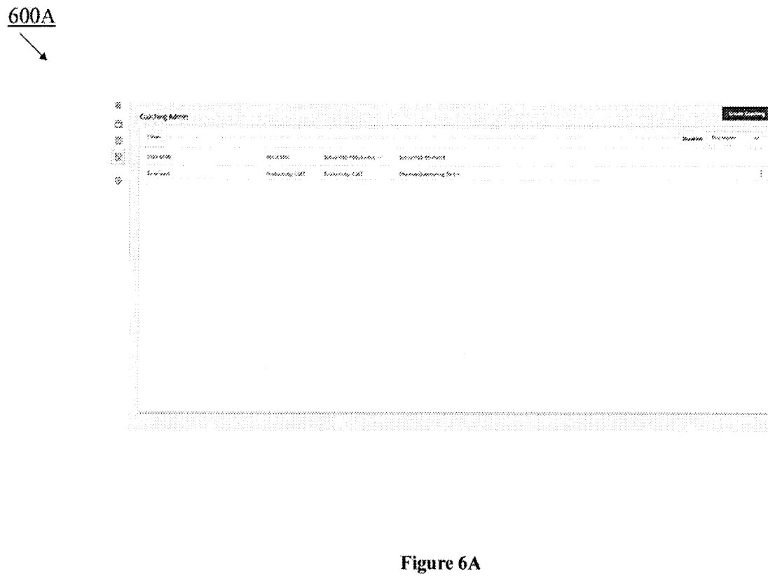

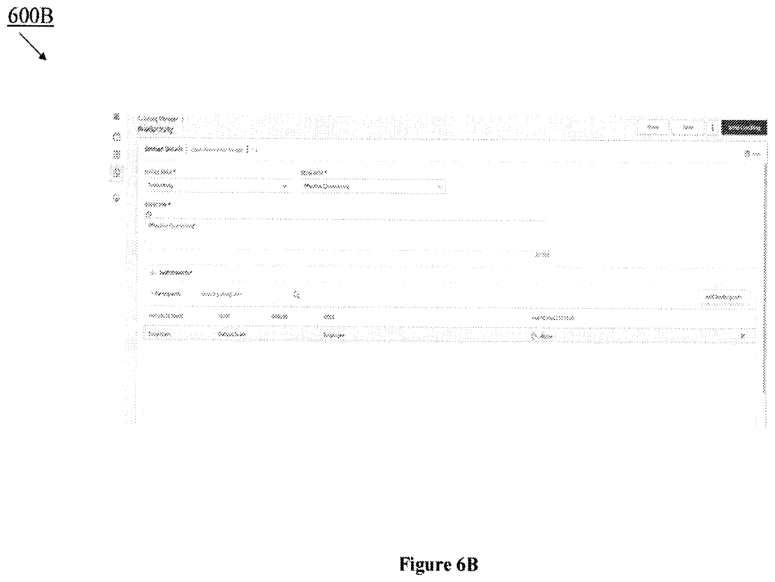

According to some embodiments of the present disclosure, the system 100A may include a User Interface (UI), e.g., UI 600B in FIG. 6B, that may be associated to the web application 165a which may enable a user 105a to select an agent for a coaching session which may be auto populated with focus area and behavior for a selected agent by the system, based on the one or more KPIs of the agent which are below a first preconfigured threshold during a preconfigured period.

FIG. 1B schematically illustrates a high-level diagram of a system 100B for consistently identifying an agent for a coaching session, and assessing relevant coaching subject to the coaching session, in a contact center, in accordance with some embodiments of the present disclosure.

According to some embodiments of the present disclosure, system 100B may include the components of system 100A in FIG. 1A and may implement a method, such as computer-implemented method 200 in FIGS. 2A-2C for consistently identifying an agent for a coaching session, and assessing relevant coaching subject to the coaching session, in a contact center.

According to some embodiments of the present disclosure, quality management 125a in FIG. 1A may be a component such as quality management 125b. In contact centers, quality management is a process of ensuring customer interactions meet a defined quality standard within all communication channels and across all agents. Additionally, quality management efforts can unearth product and operational issues that may have otherwise gone unnoticed.

According to some embodiments of the present disclosure, quality management analysts evaluate a certain percentage of interactions each period of time and strive to ensure an adequate, representative interaction-sample, i.e., interaction-recording is included for each agent. The analysts assess the interaction and provide evaluations and actionable feedback per interaction for agents for performance improvement. For example, an evaluation of adherence against standards, identified strengths and improvements, suggestions to improve effectiveness and recommendations for training.

According to some embodiments of the present disclosure, evaluations of interactions e.g., evaluation scores that are below a second preconfigured threshold during the preconfigured period may be retrieved in system 100B. The retrieved evaluations may also include CSAT score, and interaction metadata.

According to some embodiments of the present disclosure, interactions analytics component 130b may maintain information related to analytics on the interaction and insights on each interaction, such as sentiments for each participant, e.g., agent, categories which were tagged for the interaction and the like.

Interactions analytics component 130b may be implemented as an artificial Intelligence (AI) analytics omnichannel analytics, e.g., machine learning model and may identify trends and root causes across all types of interactions, voice, text, or digital interaction.

According to some embodiments of the present disclosure, requested coaching component 170b may handle coaching requests by agents. The list of agents-for-coaching may include agents that have coaching requests entered by agents during the preconfigured period as in contact centers agents have visibility to their KPI scores, such that they know if they need improvement in some areas by one or more coaching sessions. Commonly, the agents have the provision to request coaching on focus areas and behaviors or interactions when they think that a specific interaction didn't go well.

According to some embodiments of the present disclosure, when no evaluations of the retrieved interactions that are below a second preconfigured threshold during the preconfigured period are received, for the agent, the agent may be removed from the list of agents-for-coaching. Optionally, the agent may be scheduled coaching requests by the agent as stored in requested coaching component 170b.

According to some embodiments of the present disclosure, Performance Management (PM) component 135b may maintain information as to KPI scores of agents. The KPI is a metric that contact centers use to determine if they're meeting business goals such as efficiency and delivering service. Contact centers have a multitude of possible KPIs and the contact center picks the KPIs that are more suitable to holistically measure the different aspects of the operation, while not creating data overload.

According to some embodiments of the present disclosure, contact center KPIs measure labor efficiency and workload management and may include: abandon rates which measures how many contacts are being terminated by the customer before they are even connected with an agent, average speed of answer which is correlated to abandon rates, Average Speed of Answer (ASA) which measures how quickly customers are being connected to agents, service levels which is another way to measure how quickly customers are being connected to agents. The service level targets are expressed as a certain percentage of contacts answered within a certain amount of time, e.g., 80% of calls answered within 20 seconds.

According to some embodiments of the present disclosure, system 100B which may implement a method, such as computer-implemented method 200 in FIGS. 2A-2C for consistently identifying an agent for a coaching session, and assessing relevant coaching subject to the coaching session, in a contact center may use these KPIs to identify weaker areas of agent by receiving focus area and related behaviors for the one or more KPIs below the first preconfigured threshold.

According to some embodiments of the present disclosure, in a non-limiting example, when system 100B may implement a categorization of the KPI values such as:
KPI score <50—Red Zone,
KPI Score >=50 and <=70—Orange Zone,
KPI Score >70—Green Zone
   Then, the first preconfigured threshold may be set to 50 to consider coaching sessions by KPI scores that are in red zone or 70 to consider coaching sessions by KPI scores that are in the red and in the orange zones.

Currently, focus areas are areas of improvement for the agent which may be determined manually by the coach based on performance insights and additional metrics, such as productivity, Customer Satisfaction Score (CSAT), production proficiency and Average Handle Time (AHT). However, the manual determination may not be consistent and two different coaches may determine different focus areas for the agent based on the same data related to the agent. The coach frequently employs historical interactions to illustrate both aspects and areas that require improvement. The interactions are snippets of historical conversations between contact center agents and customers.

According to some embodiments of the present disclosure, the focus area may be linked or mapped to the behaviors, such as self-service, questioning, actions, acknowledgment, ownership, listening, actions, empathy, rapport, and the like.

According to some embodiments of the present disclosure, for example, productivity is a focus area that indicates that the agent should concentrate on enhancing their productivity. Behaviors include behavioral characteristics, which indicate a more specific scope improvement that is tailored to the agent. For example, to boost focus area productivity, the agent has to participate in a coaching session that will include subject matter that will train the agent to minimize idle time during calls or interactions. The preconfigured mapped behaviors to the focus area productivity may be behaviors of the contact center agents during an interaction with a customer, such as self-service, questioning, and actions: acknowledgment, as shown in FIG. 5A.

According to some embodiments of the present disclosure, in another example, CSAT may be a focus area that indicates that the agent should concentrate on enhancing customer satisfaction. Preconfigured behaviors which are mapped to the focus area CSAT may be, ownership, listening, and actions: empathy, and rapport.

According to some embodiments of the present disclosure, interaction data such as categories and behaviors 140b may be extracted from the interaction analytics module 130b. The interaction categories may be extracted from the corresponding interaction transcript by the interaction analytics module 130b by using algorithms that consider factors, such as long wait and the agent not being knowledgeable. The interaction analytics module 130b may further implement a set of Support Vector Machines (SVM) models delivered as .STM files that score agent-customer interactions for key customer satisfaction behaviors.

According to some embodiments of the present disclosure, the scores of the agent-customer interactions may be normalized into a single weighted “Behavioral Index” score for each behavior of the agent during an interaction. The Behavior Index may provide a standardized scoring approach based on the ranges of results from the analysis of interactions across companies and industries. Each behavior model that may be implemented to provide the behavioral index score may incorporate data from millions of interactions and is industry agnostic.

According to some embodiments of the present disclosure, system 100B may implement a coaching opportunity detection engine 160b, such as coaching opportunity detection engine 160a in FIG. 1A and such as computer-implemented method 200 in FIGS. 2A-2C for consistently identifying an agent for a coaching session, and assessing relevant coaching subject to the coaching session, in a contact center. The coaching opportunity detection engine 160b may implement a filtering component 175b which may include filtering interaction data based on multiple parameters such as categories labeled as negative which have been identified on poor performing KPIs, e.g., one or more KPIs below the first preconfigured threshold.

According to some embodiments of the present disclosure, identification 180b may include marking each category of the one or more categories associated to each interaction that is having an evaluation below the second preconfigured threshold to yield a list of marked categories-for-coaching and then identifying behaviors from interactions related to the determined first preconfigured number of categories for the coaching session based on the retrieved preconfigured associated focus area of the first preconfigured number of categories for the coaching session, and based on a preconfigured mapping of categories to focus areas and each focus area of the focus areas to one or more behaviors.

According to some embodiments of the present disclosure, correlation 185b may include calculating a co-relation score for each behavior in the second preconfigured number of behaviors and associated focus area and sorting the behaviors in descending order based on the calculated co-relation score.

According to some embodiments of the present disclosure, the co-relation score may be calculated by operating the following formula;

co-relation score=(median score of focus area*focus-area-weight)+(average score of behavior behavior-weight), whereby:
median score of focus area is a median score of preconfigured mapped categories to the focus area, focus-area-weight is a preconfigured weight,
average score of behavior is the calculated inversed normalized score of the behavior, and behavior-weight is a preconfigured weight.

According to some embodiments of the present disclosure, association with focus area and behavior 190b may associate the Focus area behavior as per the output of correlation 185b, i.e., linking to coaching focus areas and behavior.

According to some embodiments of the present disclosure, opportunities detection 195b may map the identified set of focus areas and behaviors and assign it as a coaching session for the agent for poor-performing KPIs by selecting a third preconfigured number of behaviors and associated focus area having highest co-relation coefficient and scheduling a coaching session with the selected third preconfigured number of behaviors and associated the focus area having highest co-relation score to the agent, which are the relevant coaching subject for the coaching session.

According to some embodiments of the present disclosure, coaching service 110b may operate the scheduled coaching session after it has been triggered in the open slot of a work-shift of the agent. The scheduled coaching session may include the selected third preconfigured number of behaviors and associated focus area having highest co-relation coefficient.

According to some embodiments of the present disclosure, coaching web application 165b may be utilized to generate coaching sessions which are assessed as relevant to an identified agent by an implemented method, such as computer-implemented method 200 in FIGS. 2A-2C for consistently identifying an agent for a coaching session, and assessing relevant coaching subject to the coaching session, in a contact center. Coaching web app 165 may provide a dashboard for a coach to identify agent for coaching. The dashboard may have the data populated based on implemented method.

According to some embodiments of the present disclosure, the system 100B may include a User Interface (UI), e.g., UI 600B in FIG. 6B, that may be associated to the web application 165b which may enable a user to select an agent for a coaching session to be auto populated with focus area and behavior for a selected agent by the system, based on the one or more KPIs of the agent which are below a first preconfigured threshold during a preconfigured period.

FIGS. 2A-2C are a high-level workflow of a computer-implemented method 200 for consistently identifying an agent for a coaching session, and assessing relevant coaching subject to the coaching session, in a contact center, in accordance with some embodiments of the present disclosure.

According to some embodiments of the present disclosure, operation 210 comprising receiving a list of one or more agents having one or more Key Performance Indicators (KPI) s below a first preconfigured threshold during the preconfigured period to yield a list of agents-for-coaching from a Project Management (PM) component.

According to some embodiments of the present disclosure, operation 215 comprising for each agent in the list of agents-for-coaching performing operations 220-265.

According to some embodiments of the present disclosure, operation 220 comprising receiving focus area and related behaviors for the one or more KPIs below the first threshold

According to some embodiments of the present disclosure, operation 225 comprising retrieving interactions and associated categories and behaviors of each agent in the list of agents-for-coaching during the preconfigured period from an interactions analytics component.

According to some embodiments of the present disclosure, operation 230 comprising receiving evaluations of the retrieved interactions that are below a second preconfigured threshold during the preconfigured period, and related interactions from a Quality Management (QM) service.

According to some embodiments of the present disclosure, operation 235 comprising marking each category of one or more categories associated to each interaction that is having an evaluation below the second preconfigured threshold to yield a list of marked categories-for-coaching.

According to some embodiments of the present disclosure, operation 240 comprising retrieving a preconfigured associated focus area for each category in the list of marked categories-for-coaching and preconfigured categories which are classified as negative. Each focus area has preconfigured one or more behaviors.

According to some embodiments of the present disclosure, operation 245 comprising determining a first preconfigured number of categories for the coaching session.

According to some embodiments of the present disclosure, the determining of the first preconfigured number of categories for the coaching session is operated by calculating an average confidence score for each category in the list of marked categories-for-coaching and sorting the categories by the average confidence score in descending order to determine the preconfigured number of categories having the highest confidence score.

According to some embodiments of the present disclosure, operation 250 comprising identifying behaviors from interactions related to the determined preconfigured number of categories for the coaching session based on the retrieved preconfigured associated focus area of the preconfigured number of categories for the coaching session.

According to some embodiments of the present disclosure, operation 255 comprising determining a second preconfigured number of behaviors from the identified behaviors for the coaching session.

According to some embodiments of the present disclosure, the determining of the second preconfigured number of behaviors for the coaching session is operated by calculating an average score for each behavior in the identified behaviors and sorting the behaviors in ascending order to determine the preconfigured number of behaviors for the coaching session.

According to some embodiments of the present disclosure, operation 260 comprising calculating a co-relation score for each behavior and associated focus area and sorting the behaviors in descending order based on the calculated co-relation score including a preconfigured mapping of categories to a focus areas and focus area to behavior.

According to some embodiments of the present disclosure, operation 265 comprising selecting a third preconfigured number of behaviors and associated focus area having highest co-relation score and scheduling a coaching session with the selected third preconfigured number of behaviors and associated focus area having highest co-relation score to the agent. The selected third preconfigured number of behaviors and associated focus area having highest co-relation score are the relevant coaching subject matter for the coaching session for the agent.

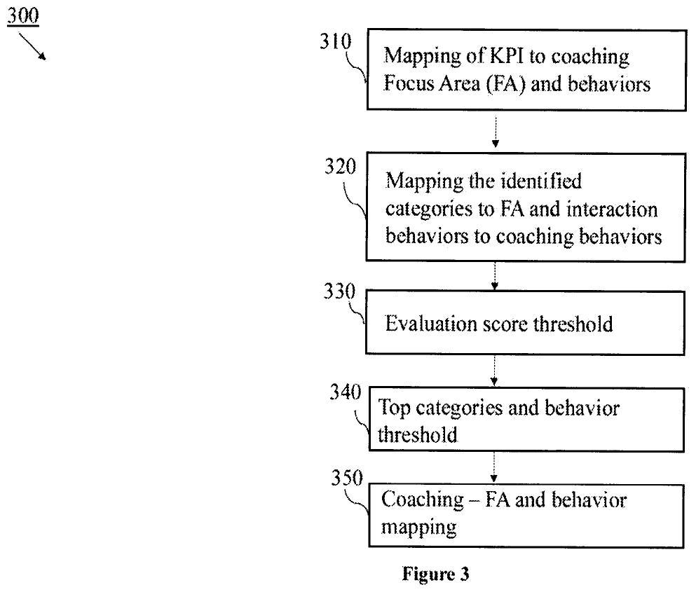

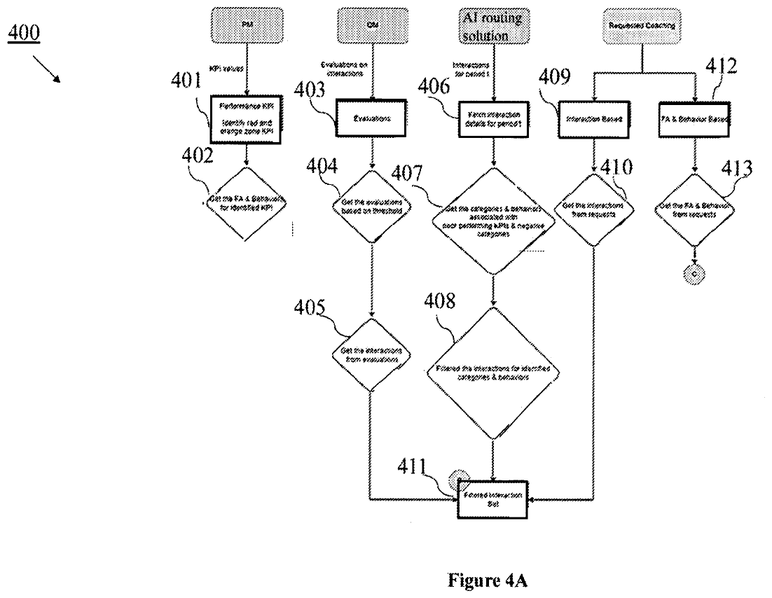

FIG. 3 shows input sources for consistently identifying an agent for a coaching session, and assessing relevant coaching subject to the coaching session, in a contact center, in accordance with some embodiments of the present disclosure.

According to some embodiments of the present disclosure, system 100A in FIG. 1A and system 100B in FIG. 1B may include a preconfigured mapping of Key Performance Indicators (KPI) coming from Performance Management (PM) component, such as performance management component 135a in FIG. 1A and such as performance management 135b in FIG. 1B to the focus areas and behaviors to be referred in the scheduled coaching session.

According to some embodiments of the present disclosure, identified categories coming from interactions analytics, such as interactions analytics 130a in FIG. 1A and such as interactions analytics 130b in FIG. 1B, may be mapped to the coaching focus areas and behaviors. The identified categories may be one or more categories associated to each interaction of the agent that has one or more KPIs below the first preconfigured threshold during the preconfigured period, that is having an evaluation score retrieved from quality management, below the second preconfigured threshold 330.

According to some embodiments of the present disclosure, top categories, and behavior threshold 340 e.g., first preconfigured number of categories for the coaching session, may include the number of top categories and behaviors need to be extracted coaching focus area and behavior for the coaching session. The determining of the first preconfigured number of categories for the coaching session may be operated by calculating an average confidence score for each category in the list of marked categories-for-coaching and sorting the categories by the average confidence score in descending order to determine the preconfigured number of categories having the highest confidence score.

According to some embodiments of the present disclosure, mapping 350 mapping of focus areas to the behavior may be the association to be used in the scheduled coaching session for the agent after the third preconfigured number of behaviors and associated focus area having highest co-relation score have been selected.

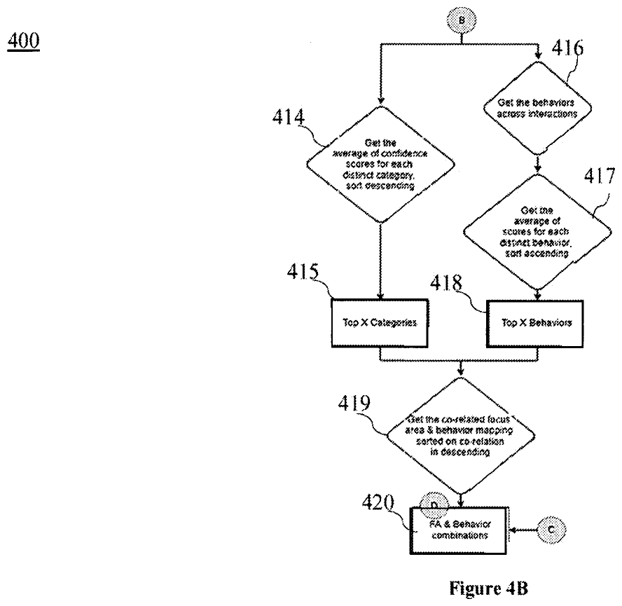

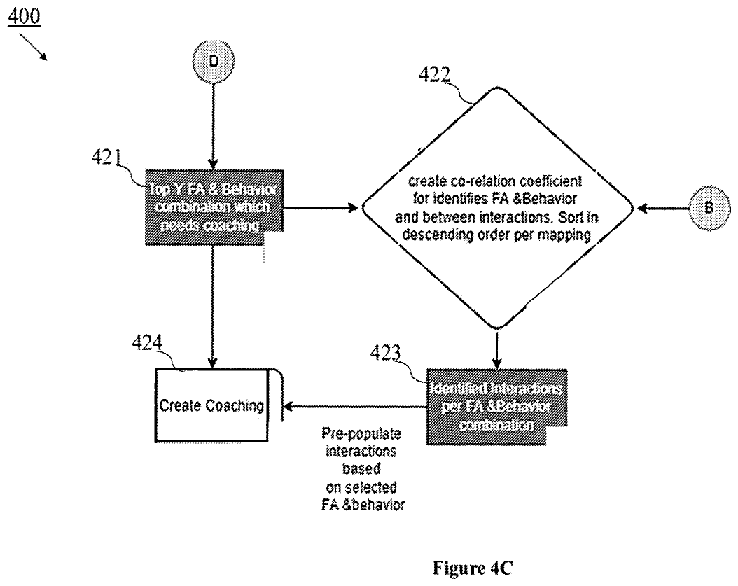

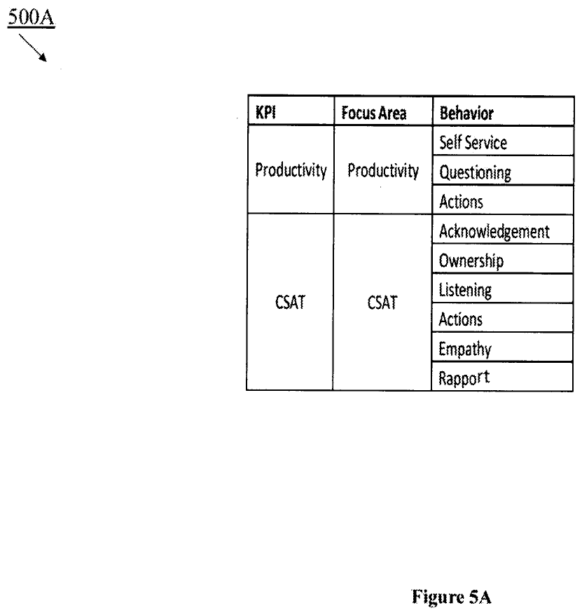

FIGS. 4A-4C is a flow diagram 400 for consistently identifying an agent for a coaching session, and assessing relevant coaching subject to the coaching session, in a contact center, in accordance with some embodiments of the present disclosure.

According to some embodiments of the present disclosure, in system 100 A in FIG. 1A and system 100B in FIG. 1B, the performance KPI for each agent may be retrieved 401 from performance management component, such as PM 135a in FIG. 1A and may be filtered, for example as follows:
If KPIscore <50 then ‘Red Zone’
If (KPIscore <=70 and KPIscore >=50) then ‘Orange Zone’
If KPIscore >70 then ‘Green Zone’
   The first preconfigured threshold may be set to 50 to consider coaching sessions by KPI scores that are in red zone or 70 to consider coaching sessions by KPI scores that are in the red and in the orange zones.

According to some embodiments of the present disclosure, for the filtered KPIs, e.g., one or more Key Performance Indicators (KPI) s below a first preconfigured threshold during a preconfigured period, get the Focus Areas (FA) and behaviors 402 based on a preconfigured mapping of categories to focus areas and each focus area of the focus areas to one or more behaviors 402.

According to some embodiments of the present disclosure, get all evaluations for the agent from quality management system, such as quality management 125a in FIG. 1A and such as quality management 125b in FIG. 1B 403 with agentId and duration as parameter.

According to some embodiments of the present disclosure, get the evaluations based on threshold 404 If Evaluationscore<EvalThreshold then select the evaluation, such that evaluations of the retrieved interactions that are below a second preconfigured threshold during the preconfigured period may be retrieved from the Quality Management (QM) service, and get related interactions 405. Each evaluation has associated interaction on which this evaluation was conducted. Based on filtered evaluation the associated interaction is retrieved. This interaction then added to ‘the filtered interaction’ set for further processing.

According to some embodiments of the present disclosure, fetch interaction details for period t 406 which were performed by the agent from an Artificial Intelligence (AI) solution for the preconfigured period and then, get the categories and behaviors associated with low performing KPIs, e.g., one or more KPIs below the first preconfigured threshold and categories labeled as negative.

According to some embodiments of the present disclosure, get the categories and behaviors associated with poor performing KPIs and negative categories. The interactions which are associated with low performing KPIs are identified as the input from operation 402, with the focus areas and behaviors identified for poor performing KPIs, the configured mapping of interaction and behavior to coaching focus areas and behaviors and the categories and associated score and behavior with confidence score for each interaction.

According to some embodiments of the present disclosure, filtered the interactions for identified categories and behaviors 408. Get the interactions which meets the criteria as:
i. Where interaction_categories in (filtered_coaching_focus_area)
ii. Where interaction_behavior in ((filtered_coaching_behavior) and confidencescore >0)
   These interactions then added to filtered interaction set for further processing.

According to some embodiments of the present disclosure, a requested coaching may be a coaching session that may include requests from the agent for a coaching session 409 for specific interaction or a set of one or more focus areas where each focus area may be preconfigured to be mapped to one or more behaviors 412, for example, as shown in FIG. 5A. When the requested coaching is interactions based 409 the details of the interaction, such as interaction metadata and interaction identifier may be retrieved 410. When the coaching session is based on a set of one or more focus areas where each focus area may be preconfigured to be mapped to one or more behaviors the set of one or more focus areas where each focus area is preconfigured to be mapped to one or more behaviors may be retrieved 413.

According to some embodiments of the present disclosure, the filtered interactions set 411 of interactions may include interactions that have poor performing one or more KPIs, e.g., one or more KPIs below a first preconfigured threshold during a preconfigured period, with poor evaluation score of the interactions e.g., evaluation score below a second preconfigured threshold during the preconfigured period.

According to some embodiments of the present disclosure, to determine the first preconfigured number of categories for the coaching session from the list of marked categories-for-coaching get the average of confidence scores for each distinct category and sort descending 414 may include calculating an average confidence score for each category in the list of marked categories-for-coaching and sorting the categories by the average confidence score in descending order to determine the preconfigured number of categories having the highest confidence score, i.e., top x categories 415.

According to some embodiments of the present disclosure, get behaviors across interaction 416 may include identifying one or more behaviors from the set of interactions 411 by identifying behaviors from interactions related to the determined first preconfigured number of categories for the coaching session based on the retrieved preconfigured associated focus area of the first preconfigured number of categories for the coaching session, and based on a preconfigured mapping of categories to focus areas and each focus area of the focus areas to one or more behaviors.

According to some embodiments of the present disclosure, get the average of scores for each distinct behavior sort ascending 417 by calculating an average score for each behavior in the identified behaviors and sorting the behaviors in ascending order to determine the preconfigured number of behaviors for the coaching session to determine a second preconfigured number of behaviors from the identified behaviors for the coaching session, i.e., top x behaviors 418.

According to some embodiments of the present disclosure, get the co-related focus area and behavior mapping sorted on co-relation in descending 419 by calculating a co-relation score for each behavior in the second preconfigured number of behaviors and associated focus area and sorting the behaviors in descending order based on the calculated co-relation score. The co-relation score may be calculated based on the top x categories 415, top x behaviors 418 and preconfigured interaction behaviors mapping to coaching behaviors, as shown in FIG. 5C and the preconfigured mapping of categories to focus areas and each focus area of the focus areas to one or more behaviors, as shown in FIGS. 5A-5B. The co-relation score may be built as calculated inversed normalized score for each identified behavior, i.e., top x behaviors 418.

According to some embodiments of the present disclosure, the inversed normalized score may be calculated by:

inversed normalized score=(max preconfigured score-average score)*(100/max preconfigured score). For example, for a maximum preconformed score 5 and focus area average score is 1.2, then (5−1.2)*100/5=76, mapping top x categories 415 to focus areas based on a preconfigured mapping, e.g., as shown in FIG. 5B, then mapping the top x behaviors 418 to coaching behaviors, e.g., as shown in FIG. 5C and calculating the median for the focus area using the average score values of the top x categories 415, based on the following formula:

$$Med ( X ) = \{ \begin{matrix}X [ \frac{n + 1}{2} ] & if n is odd \\ \frac{X [ \frac{n}{2} ] + X [ \frac{n}{2} + 1 ]}{2} & if n is even\end{matrix}$$

whereby:
X is an ordered list of values in data set, which is the list of focus area scores, and
n is a number of values in the dataset, which is the number of focus areas.

According to some embodiments of the present disclosure, create co-relation coefficient for identified focus area and behavior and between interactions. Sort in descending order per mapping 422 may include the co-relation score for each behavior in the top x behaviors 418 and the associated focus area may be calculated 422 based on the following formula:

co-relation score=(median score of focus area*focus-area-weight)+(average score of behavior*behavior-weight). For example, when the focus-area-weight is preconfigured to 60% and behavior-weight to 40% then,
co-relation score=(median score of focus Area*0.6)+ (average score of behavior*0.4)=
median score of focus area: median of categories scores from filtered interactions
average score of behavior: Also represents inversed normalized score of behavior which is inverse value of average of behavior score in interaction.

According to some embodiments of the present disclosure, sorting the behaviors in descending order based on the calculated co-relation score and then selecting a third preconfigured number of behaviors and associated focus area having highest co-relation score and scheduling a coaching session with the selected third preconfigured number of behaviors and associated focus area having highest co-relation score to the agent 424.

According to some embodiments of the present disclosure, focus area and behavior combinations 420 may include the selected third preconfigured number of behaviors and associated focus area having highest co-relation score to the agent which are top y focus area and behavior combination which need coaching 421 that may be included in the scheduled coaching session for the agent when the coaching session is created, e.g., create coaching 424.

According to some embodiments of the present disclosure, the identified interactions per focus area and behavior combination 423 may be the interactions which are attached or populated to the scheduled coaching session. The identifying of interactions may be by filtering the set of interactions 411 based on the combination of the focus area and related behaviors in the selected third preconfigured number of behaviors and associated focus area having highest co-relation score 421. Optionally, only a preconfigured number of interactions from the filtered interactions may be populated to the scheduled coaching sessions based on presence of identified focus area and behavior, sorted by co-relation score in descending order.

FIGS. 5A-5K show simulation and test results for consistently identifying an agent for a coaching session, and assessing relevant coaching subject to the coaching session, in a contact center, in accordance with some embodiments of the present disclosure.

According to some embodiments of the present disclosure, table 500A is an example of a preconfigured mapping of KPI productivity to focus area productivity to behaviors self-service, questioning and actions: acknowledgment and an example of KPI Customer Satisfaction score (CSAT) to focus area CSAT to behaviors ownership and listening and actions: empathy and rapport.

According to some embodiments of the present disclosure, table 500B is an example of a preconfigured mapping of categories abandoned call, disconnected call, no answer, customer escalated, contacted multiple times, agent curses, agent unhelpful, negative chat, agent difficult to understand, agent unhelpful and unhelpful process to a focus area CSAT and categories agent not knowledgeable, agent unable to assist, agent not listening, agent unhelpful, negative chat and agent idle to focus area productivity.

According to some embodiments of the present disclosure, table 500C is an example of a preconfigured mapping of behaviors which were identified in an interaction by a module such as interactions analytics component 130a in FIG. 1A, and such as interactions analytics 130b in FIG. 1B, to behaviors for a coaching session.

According to some embodiments of the present disclosure, table 500D is an example of interactions, each having a segment Id for an agent having agent ID ‘I’ and related tagged one or more categories of the interactions with confidence score and behaviors which were identified in an interaction by a module such as interactions analytics component 130a in FIG. 1A, and such as interactions analytics 130b in FIG. 1B. Each behavior has a metric which indicates a performance score of the agent for that behavior during the interaction.

According to some embodiments of the present disclosure, table 500E is an example of an evaluation ID and evaluation score for each interaction with related tagged categories with confidence score and behaviors metrics.

According to some embodiments of the present disclosure, table 500F is an example of categories each category has a total score and number of occurrences to calculate the average confidence score for each category. In the table 500F the categories e.g., the list of marked categories-for-coaching, are sorted in descending order based on the average confidence score.

According to some embodiments of the present disclosure, table 500G is an example of identified behaviors each behavior has a total score and number of occurrences to calculate the average confidence score for each behavior. In the table 500G the behaviors, which were identified in the interaction, are sorted in descending order based on the average confidence score to determine a second preconfigured number of behaviors from the identified behaviors 505 as the behaviors having the lowest average score.

According to some embodiments of the present disclosure, table 500H is an example of focus areas productivity and CSAT and related one or more categories and average confidence scores as shown in FIG. 5F with mapped coaching behaviors and related interaction behaviors with average confidence score, as shown in FIG. 5G and inversed normalized score.

The inversed normalized score of behavior agent unhelpful may be calculated to be 76 by formula:
inversed normalized score=(max preconfigured score-average score)*(100/max preconfigured score). The max preconfigured score may the maximum configured score for the behavior and the average score may be the average score of the behavior. For example, when the average score is 1.2 and the max preconfigured score is 5, then, the calculated inversed normalized score=(5−1.2)*(100/5)=76.

According to some embodiments of the present disclosure, table 500I is an example of focus areas productivity and CSAT and median focus area score and related behaviors with average confidence score and a calculated co-relation score.

According to some embodiments of the present disclosure, table 500J is an example of focus area weight and behavior weight that may be used to the calculation of co-relation score for each behavior and associated focus area in the determined second preconfigured number of behaviors for the coaching session by formula:

co-relation score=(median score of focus area*focus-area-weight)+(average score of behavior*behavior-weight).

According to some embodiments of the present disclosure, table 500K is an example of co-relation score calculations based on the focus area weight and behavior weight in table 500J. For focus area CSAT and behavior ownership the co-relation score may be 83.958 based on median focus area CSAT score 78.33, as in FIG. 5I, focus-area-weight 0.6, behavior-weight 0.4 as in FIG. 5J, average score of ownership 92.4 as in FIG. 5I and the following calculation:

$$co - relation score = ( 78.33 * 0.6 ) + ( 92.4 * 0.4 ) = 83.958 .$$

FIGS. 6A-6B show screenshots of scheduled coaching sessions for agents, in accordance with some embodiments of the present disclosure.

According to some embodiments of the present disclosure, table 600A FIG. 6A is an example of a screenshot of a User Interface (UI) that may be associated to a web application in a system, such as system 100A in FIG. 1 and such as system 100b in FIG. 1B. The UI includes coaching sessions for agents and the focus area and behavior included in the scheduled coaching session.

According to some embodiments of the present disclosure, table 600A FIG. 6B is an example of a screenshot of a User Interface (UI) that may be associated to a web application in a system, such as system 100A in FIG. 1 and such as system 100b in FIG. 1B. The UI includes a coaching session that is auto populated by the system with focus area and behavior for a user-selected agent.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computer-implemented method for consistently identifying an agent for a coaching session, and assessing relevant coaching subject to the coaching session, in a contact center, said computer-implemented method comprising:
(i) receiving a list of one or more agents having one or more Key Performance Indicators (KPI) s below a first preconfigured threshold during a preconfigured period to yield a list of agents-for-coaching from a Project Management (PM) component;
for each agent in the list of agents-for-coaching:
(ii) receiving focus area and related behaviors for the one or more KPIs below the first preconfigured threshold;
(iii) retrieving interactions and associated one or more categories and behaviors during the preconfigured period from an interactions analytics component;
(iv) retrieving evaluations of the retrieved interactions that are below a second preconfigured threshold during the preconfigured period, and related interactions from a Quality Management (QM) service;
(v) marking each category of the one or more categories associated to each interaction that is having an evaluation below the second preconfigured threshold to yield a list of marked categories-for-coaching;
(vi) retrieving a preconfigured associated focus area for each category in the list of marked categories-for-coaching that is classified as negative,
wherein each focus area has preconfigured one or more behaviors;
(vii) determining a first preconfigured number of categories for the coaching session;
(viii) identifying behaviors from interactions related to the determined first preconfigured number of categories for the coaching session based on the retrieved preconfigured associated focus area of the first preconfigured number of categories for the coaching session and based on a preconfigured mapping of categories to focus areas and each focus area of the focus areas to one or more behaviors;
(ix) determining a second preconfigured number of behaviors from the identified behaviors for the coaching session;
(x) calculating a co-relation score for each behavior in the second preconfigured number of behaviors and associated focus area and sorting the behaviors in descending order based on the calculated co-relation score; and
(xi) selecting a third preconfigured number of behaviors and associated focus area having highest co-relation score and scheduling a coaching session with the selected third preconfigured number of behaviors and associated focus area having highest co-relation score to the agent.

2. The computer-implemented method of claim 1, wherein the determining of the first preconfigured number of categories for the coaching session is operated by calculating an average confidence score for each category in the list of marked categories-for-coaching and sorting the categories by the average confidence score in descending order to determine the preconfigured number of categories having the highest confidence score.

3. The computer-implemented method of claim 1, wherein the determining of the second preconfigured number of behaviors for the coaching session is operated by calculating an average score for each behavior in the identified behaviors and sorting the behaviors in ascending order to determine the second preconfigured number of behaviors for the coaching session.

4. The computer-implemented method of claim 1, wherein the list of agents-for-coaching further includes coaching requests from agents during the preconfigured period.

5. The computer-implemented method of claim 1, wherein the coaching session includes one or more sessions.

6. The computer-implemented method of claim 1, wherein the received one or more KPIs of each agent includes at least one of: (i) abandon rate; (ii) average speed of answer; (iii) Average Handling time (AHT); (iv) service level; (v) productivity; (vi) Customer Satisfaction (CSAT); and (vii) proficiency.

7. The computer-implemented method of claim 1, wherein the calculated co-relation score for each behavior and associated focus area in the determined second preconfigured number of behaviors for the coaching session is based on an inversed normalized score for the behavior, and wherein the inversed normalized score is calculated by:
inversed normalized score=(max preconfigured score-average score)*(100/max preconfigured score)
whereby,
max preconfigured score is a maximum score for the behavior, and
average score is an average score of the behavior during the preconfigured period.

8. The computer-implemented method of claim 1, wherein the calculating of the co-relation score for each behavior and associated focus area in the determined second preconfigured number of behaviors for the coaching session is calculated by:
co-relation score=(median score of focus area*focus-area-weight)+(average score of behavior*behavior-weight),
whereby:
median score of focus area is a median score of preconfigured mapped categories to the focus area,
focus-area-weight is a preconfigured weight,
average score of behavior is the calculated inversed normalized score of the behavior, and
behavior-weight is a preconfigured weight.

9. The computer-implemented method of claim 1, wherein the scheduling of the coaching session includes scheduling the coaching session in an open slot of a work-shift of the agent.

10. The computer-implemented method of claim 1, wherein said computer-implemented method further comprising sending a notification to a computerized-device of the agent as to the scheduled coaching session, and wherein the notification includes details of the selected preconfigured number of behaviors and associated focus area having highest co-relation score.

11. The computer-implemented method of claim 1, wherein when no evaluations of the retrieved interactions that are below a second preconfigured threshold during the preconfigured period are received, the agent is removed from the list of agents-for-coaching.

12. The computer-implemented method of claim 1, wherein the identifying of the behaviors from interactions related to the determined first preconfigured number of categories for the coaching session based on the retrieved preconfigured associated focus area of the first preconfigured number of categories and behaviors for the coaching session is operated by the interactions analytics module.
